(19) United States
(12) Patent Application Publication
(10) Pub. No.: US 2012/0306971 A1
(43) Pub. Date: Dec. 6, 2012

(54) LIQUID EJECTING APPARATUS

(75) Inventors: Masaru KOBASHI, Matsumoto (JP); Yoichi YAMADA, Shiojiri (JP); Toshiya OKADA, Chino (JP)

(73) Assignee: SEIKO EPSON CORPORATION, Tokyo (JP)

(21) Appl. No.: 13/480,005

(22) Filed: May 24, 2012

(30) Foreign Application Priority Data
May 30, 2011 (JP) 2011-119855

(51) Int. Cl. B41J 2/04

(52) U.S. Cl. 347/54

(57) ABSTRACT

A liquid ejecting apparatus includes: a liquid ejecting head having a nozzle formation surface in which a nozzle is formed that causes a liquid to be ejected through the nozzle toward a landing target by driving a pressure generation unit; a support unit that supports the landing target that is disposed at a landing-capable distance from the nozzle formation surface of the liquid ejecting head; and a liquid droplet collection unit disposed in a location that is distanced from an ejection region. Here, the liquid droplet collection unit has a landing surface on which the liquid lands when carrying out flushing operations; and the distance between the landing surface and the nozzle formation surface of the liquid ejecting head is set to be smaller than the landing-capable distance, and the nozzle formation surface and the landing surface are set to the same voltage at least during the flushing operations.

The entire disclosure of Japanese Patent Application No. 2011-119855, filed May 30, 2011 is expressly incorporated by reference herein.

### BACKGROUND

1. Technical Field

The present invention relates to liquid ejecting apparatuses such as ink jet recording apparatuses, and particularly relates to liquid ejecting apparatuses that eject a liquid from within pressure chambers through nozzles by driving pressure generation units.

2. Related Art

A liquid ejecting apparatus is an apparatus that includes a liquid ejecting head, and that ejects various types of liquid from this liquid ejecting head. Image recording apparatuses such as ink jet printers, ink jet plotters, and so on can be given as examples of such a liquid ejecting apparatus, but recently, such technique is also being applied in various types of manufacturing apparatuses that exploits an advantage in which extremely small amounts of liquid can be caused to land in predetermined positions in a precise manner. For example, such technology is being applied in display manufacturing apparatuses that manufacture color filters for liquid-crystal displays and so on, electrode formation apparatuses that form electrodes for organic EL (electroluminescence) displays, FEDs (field emission displays), and so on, chip manufacturing apparatuses that manufacture biochips (biochemical devices), and the like. While a recording head in an image recording apparatus ejects ink in liquid form, a coloring material ejecting head in a display manufacturing apparatus ejects R (red), G (green), and B (blue) coloring material solutions. Likewise, an electrode material ejecting head in an electrode formation apparatus ejects an electrode material in liquid form, and a bioorganic matter ejecting head in a chip manufacturing apparatus ejects a bioorganic matter solution.

In recording heads used in such printers or the like, there is a recent trend toward a reduction in the amounts of ink ejected through the nozzles, in order to respond to demands for increased image quality and so on. In order to cause such minute liquid droplets to accurately land on a recording medium, the initial velocities of the liquid droplets are set to be comparatively high. Through this, the liquid droplets ejected through the nozzles are stretched out during flight, which splits the liquid droplets into an initial main liquid droplet (a primary liquid droplet), a smaller first satellite liquid droplet that is produced following the main liquid droplet, and an even smaller second satellite liquid droplet. The velocity of part or all of this second satellite liquid droplet sometimes experiences a sudden drop due to the viscous resistance of the air, turning into mist rather than reaching the recording medium. There has thus been a problem in that the second satellite liquid droplet that has turned into mist has soiled the interior of the apparatus, adhering to the recording head, electrical circuitry, and so on, and causing operational problems. Such a problem is particularly apparent during a flushing operation, in which liquid droplets are ejected into a flushing box (ink receiving unit) positioned away from the recording medium. In other words, the flushing operation is designed to forcefully eject thickened liquid, air bubbles, and so on from within the recording head, and is a process for ejecting ink into the flushing box that is separate from recording operations; in this flushing operation, the initial velocities of the liquid droplets are set to be higher than those in normal recording operations. Accordingly, the liquid ejected through the nozzles stretches out even more, and thus mist is more likely to be produced. Meanwhile, in the case where the liquid has thickened, the liquid ejected through the nozzles stretches out even more, and thus mist is even more likely to be produced.

In order to prevent such a problem, attempts have been made to control the dispersal of mist during flushing operations by employing a configuration in which the height position of the recording head can be changed and by then carrying out control so that the distance between the recording head (nozzles) and the flushing box during flushing operations is smaller than the distance between the recording head (nozzles) and the recording medium during recording operations (for example, see JP-A-2007-111932).

However, as shown in the schematic diagram illustrated in FIG. 8A, it is common to use a material that can easily be negatively charged in a triboelectric series for a flushing box 80 (for example, PU (polyurethane), PVC (polyvinyl chloride), PTFE (polytetrafluoroethylene), PET (polyethylene terephthalate), or the like), and as a result, it is easy for the flushing box 80 to be negatively charged by friction with an air flow (air) arising due to the transport of the recording medium or the like. The flushing box 80 that has been negatively charged then forms an electrical field with a nozzle plate 82 in which nozzles 81 are formed. If ink is ejected through the nozzles 81 in this state, as the ink extends toward the flushing box 80, the leading portions of the liquid droplets that are closest to the flushing box 80 (portions that correspond to main liquid droplets Md) will be induced to a positive charge as a result of the electrostatic induction from the negatively-charged flushing box 80. Meanwhile, the following portions of the liquid droplets that are closest to the nozzles 81 on the opposite side will be induced to a negative charge. Then, as shown in FIG. 8B, in the case where the ink ejected through the nozzles 81 has split into, for example, a main liquid droplet Md, a first satellite liquid droplet Sd1, and a second satellite liquid droplet (mist) Sd2, the main liquid droplet Md is positively charged, the second satellite liquid droplet Sd2 is negatively charged, and the first satellite liquid droplet Sd1 remains essentially uncharged. In this case, even if the main liquid droplet Md and the first satellite liquid droplet Sd1 land in the flushing box 80, the second satellite liquid droplet Sd2 will rebound off of the negatively-charged flushing box 80, and part thereof will turn to mist without landing in the flushing box 80. This free-floating mist may then be carried by an air flow or the like, landing on components within the printer and soiling the interior of the printer.

Because the strength of the stated electrical field is in inverse proportion to the distance between the top surface of the flushing box 80 (the surface that opposes the nozzle plate 82) and the nozzle plate 82 (a nozzle formation surface), reducing this distance as per the liquid ejecting apparatus described in JP-A-2007-111932 will increase the strength of the electrical field that is to be formed and will thus cause the charge in the second satellite liquid droplet Sd2 resulting from the electrostatic induction to become even stronger. Accordingly, the second satellite liquid droplet Sd2 rebounds even more strongly off of the flushing box 80, thus increasing the second satellite liquid droplets Sd2 that turn to mist. As a result, the stated technique has had the opposite effect of causing the interior of the printer to be soiled even more.

The phenomenon described thus far is not limited to piezoelectric vibrators, and also occurs in other pressure generation units that operate through the application of driving voltages, such as heating elements.

### SUMMARY

It is an advantage of some aspects of the invention to provide a liquid ejecting apparatus capable of causing a liquid ejected through a nozzle to land on a predetermined member during a flushing operation and preventing the liquid from adhering to other members within the apparatus.

A liquid ejecting apparatus according to an aspect of the invention includes: a liquid ejecting head, having a nozzle formation surface in which a nozzle that ejects a liquid is formed and a pressure generation unit that causes a fluctuation in the pressure of a liquid within a pressure chamber, that causes the liquid to be ejected through the nozzle toward a landing target by driving the pressure generation unit; a support unit that, during ejection operations, supports the landing target that is disposed at a landing-capable distance from the nozzle formation surface of the liquid ejecting head; and a liquid droplet collection unit disposed in a location that is distanced from an ejection region in the support unit, the ejection region being a region in which the liquid is ejected onto the landing target from the liquid ejecting head. Here, the liquid droplet collection unit has a landing surface on which the liquid lands when carrying out flushing operations that eject the liquid from the liquid ejecting head into the liquid droplet collection unit; and the distance between the landing surface and the nozzle formation surface of the liquid ejecting head when carrying out the flushing operations is set to be smaller than the landing-capable distance, and the nozzle formation surface and the landing surface are set to the same voltage at least during the flushing operations.

According to this aspect of the invention, an electrical field is not formed between the nozzle formation surface of the liquid ejecting head and the landing surface of the liquid droplet collection unit, and thus the second satellite liquid droplet can be prevented from being charged through electrostatic induction. In addition, setting the distance between the landing surface and the nozzle formation surface to be smaller than the landing-capable distance makes it possible to cause the second satellite liquid droplet to land on the liquid droplet collection unit before losing velocity, which makes it possible to suppress the occurrence of misting. Furthermore, the flight time of the second satellite liquid droplet is reduced, which makes it possible to suppress positive charging due to the Lenard effect. This reduces mist adhering to other components within the apparatus (for example, components that are negatively charged with ease, such as motors, driving belts, linear scales, and so on). As a result, malfunctions caused by the adherence of mist are suppressed, and the durability and reliability of the liquid ejecting apparatus is increased. Here, the “landing-capable distance” refers to a distance at which at least the main liquid droplet in the liquid droplet ejected through the nozzle is capable of landing with certainty on the landing target in a state in which there is no influence from electrical fields or the like.

In the above aspect, it is preferable for the liquid ejecting apparatus to further include a voltage application unit that applies a voltage to the nozzle formation surface and the landing surface, and for a negative voltage to be applied to the nozzle formation surface and the landing surface.

According to this aspect, an electrical field is formed toward the nozzle formation surface and the landing surface from other components within the liquid ejecting apparatus, which makes it possible to cause the second satellite liquid droplet that has been positively charged due to the Lenard effect to land on the nozzle formation surface and the landing surface; this in turn makes it possible to suppress the occurrence of misting with even more certainty.

### BRIEF DESCRIPTION OF THE DRAWINGS

The invention will be described with reference to the accompanying drawings, wherein like numbers reference like elements.

FIG. 1 is a perspective view illustrating the configuration of a printer.

FIG. 2 is a cross-sectional view illustrating the principle constituent elements of a recording head.

FIG. 3 is a cross-sectional view illustrating the configuration of a piezoelectric vibrator.

FIG. 4 is a cross-sectional view illustrating the principle constituent elements that configure a flushing box.

FIG. 5 is a cross-sectional view illustrating the principle constituent elements that configure a flushing box according to a second embodiment.

FIG. 6 is a cross-sectional view illustrating the principle constituent elements that configure a flushing box according to a third embodiment.

FIG. 7 is a cross-sectional view illustrating the principle constituent elements that configure a flushing box according to a fourth embodiment.

FIGS. 8A and 8B are schematic diagrams illustrating ink ejected through a nozzle being charged in a configuration in which a flushing box is charged.

### DESCRIPTION OF EXEMPLARY EMBODIMENTS

Hereinafter, embodiments of the invention will be described with reference to the appended drawings. Although various limitations are made in the embodiments described hereinafter in order to illustrate a specific preferred example of the invention, it should be noted that the scope of the invention is not intended to be limited to these embodiments unless such limitations are explicitly mentioned hereinafter. An ink jet recording apparatus 1 (referred to as a “printer”) will be given hereinafter as an example of a liquid ejecting apparatus according to the invention.

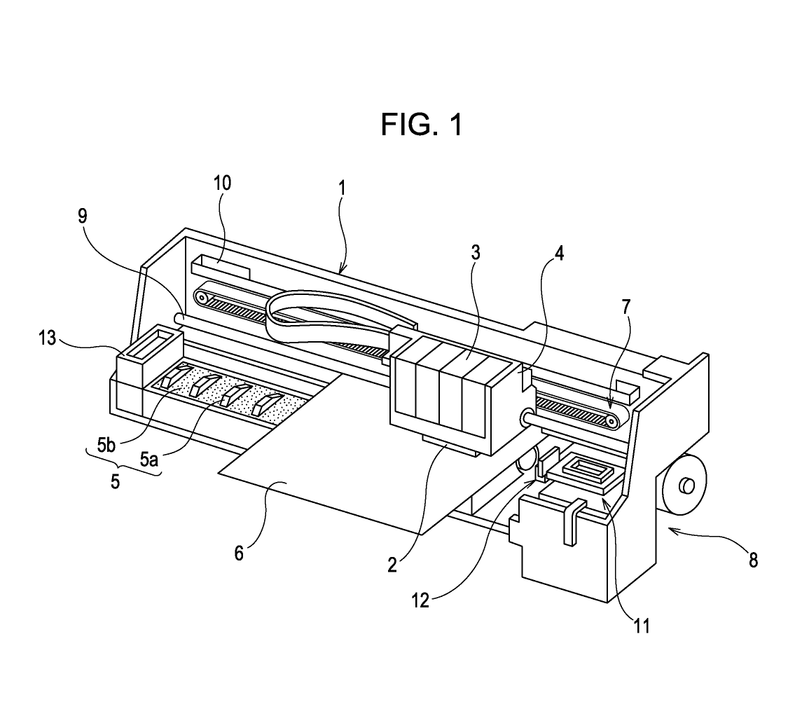

FIG. 1 is a perspective view illustrating the configuration of a printer 1. The printer 1 includes: a carriage 4, to which a recording head 2 serving as a type of liquid ejecting head is attached, and to which an ink cartridge 3 serving as a type of liquid supply source is attached in a removable state; a platen 5 (corresponding to a “support unit” according to the invention) that is disposed below the recording head 2 during recording operations; a flushing box 13 (corresponding to a “liquid droplet collection unit” according to the invention) that is disposed below the recording head 2 during flushing operations; a carriage movement mechanism 7 that moves the carriage 4 back and forth in a paper width direction of recording paper 6 (a type of recording medium and landing target), or in other words, in the main scanning direction; and a transport mechanism 8 that transports the recording paper 6 in the sub scanning direction that is orthogonal to the main scanning direction.

The carriage 4 is attached in a state in which it is axially supported by a guide rod 9 that is erected along the main scanning direction, and the configuration is such that the carriage 4 moves in the main scanning direction along the guide rod 9 as a result of operations performed by the carriage movement mechanism 7. The position of the carriage 4 in the main scanning direction is detected by a linear encoder 10, and that detection signal, or in other words, an encoder pulse (a type of position information) is sent to a printer controller (not shown) for controlling the various components of the printer 1. The linear encoder 10 is a type of position information output unit, and outputs an encoder pulse EP based on the scanning position of the recording head 2 as position information in the main scanning direction.

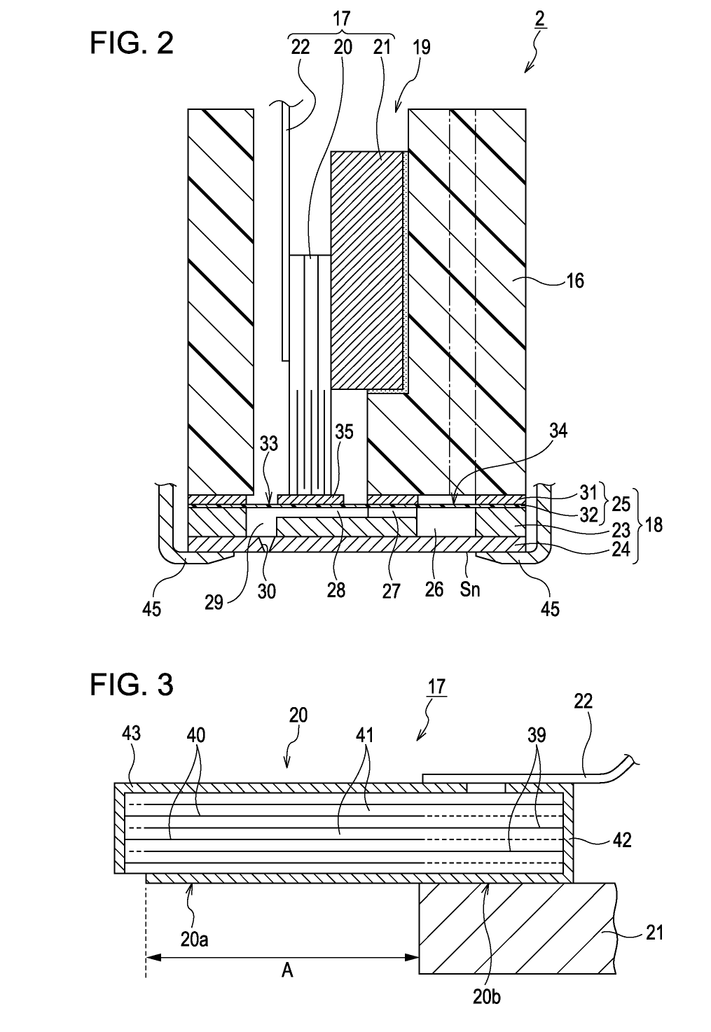

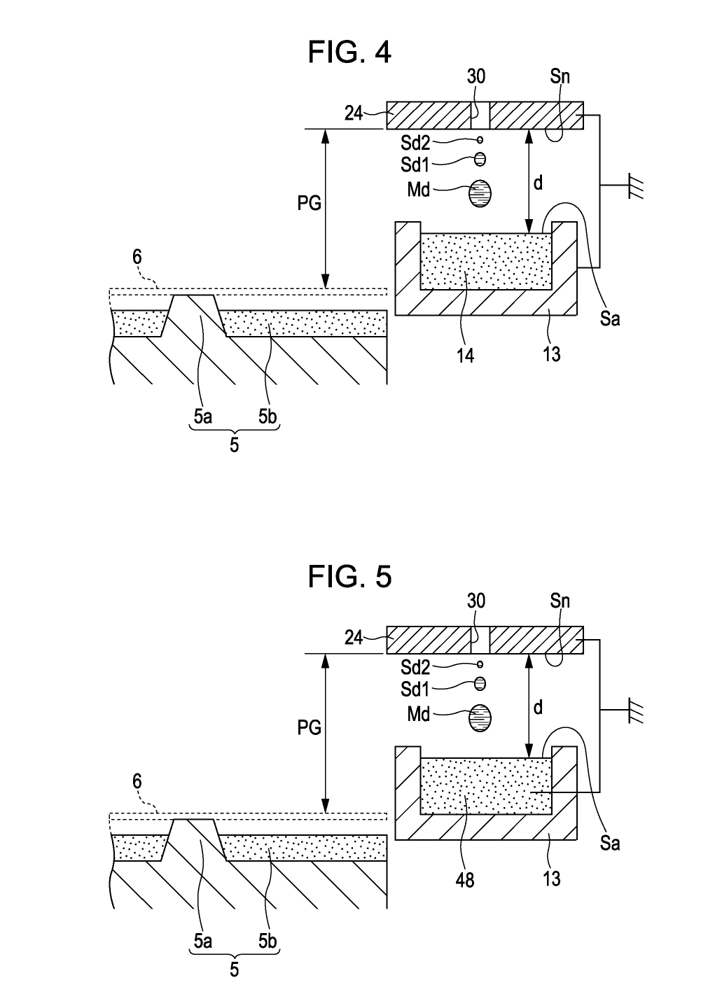

A home position, which serves as a base point for the scanning performed by the carriage 4, is set within the movement range of the carriage 4 in an end region that is outside of the recording region. A capping member 11 that seals a nozzle formation surface Sn of the recording head 2 (that is, a nozzle plate 24; see FIGS. 2 and 4) and a wiper member 12 for wiping the nozzle formation surface Sn are provided at the home position in this embodiment. The printer 1 is configured so as to be capable of so-called bidirectional recording, in which text, images, or the like are recorded upon the recording paper 6 both when the carriage 4 is outbound, moving toward the end that is on the opposite side of the home position, and when the carriage 4 is inbound, returning toward the home position from the end that is on the opposite side of the home position.

The recording head 2 attached to the carriage 4 moves above the recording paper 6 and above the flushing box 13 due to the movement of the carriage 4, and carries out recording operations for ejecting ink toward the recording paper 6 and flushing operations for ejecting ink toward the flushing box 13. As shown in FIG. 2, the recording head 2 includes a case 16, a vibrator unit 17 that is housed within the case 16, a flow channel unit 18 that is bonded to the bottom surface (the end surface) of the case 16, a cover member 45, and so on. The stated case 16 is created using, for example, an epoxy resin; a housing cavity 19 for housing the vibrator unit 17 is formed within the case 13. The vibrator unit 17 includes piezoelectric vibrators 20 that function as a type of pressure generation unit, an anchor plate 21 that is bonded to the piezoelectric vibrators 20, and a flexible cable 22 that supplies driving signals to the piezoelectric vibrators 20.

FIG. 3 is a cross-sectional view illustrating the configuration of the vibrator unit 17 along the lengthwise direction of the element. As shown in FIG. 3, each piezoelectric vibrator 20 is a stacked-type piezoelectric vibrator 20 in which a piezoelectric material 41 is stacked in an alternating manner with a common internal electrode 39 and individual internal electrodes 40 on either side thereof. Here, the common internal electrode 39 is a common electrode for all of the piezoelectric vibrators 20, and is set to a ground potential. In addition, the individual internal electrodes 40 are electrodes whose potentials fluctuate in accordance with an ejection driving pulse DP in an applied driving signal. In this embodiment, the portion in each of the piezoelectric vibrators 20 from the leading edge of the vibrator to approximately half to ⅔ along the lengthwise direction of the vibrator (that is, the direction orthogonal to the stacking direction) serves as a free end 20a. Meanwhile, the remaining portion of each of the piezoelectric vibrators 20, or in other words, the portion spanning from the base of the free end 20a to the base end of the vibrator, serves as a base end 20b.

An active region (overlap portion) A in which the common internal electrode 39 and the individual internal electrodes 40 overlap is formed at the free end 20a. When a potential difference is imparted on these internal electrodes, the piezoelectric material 41 in the active region A is activated and deforms, and the free end 20a displaces so as to extend/shrink in the lengthwise direction of the vibrator. The base end of the common internal electrode 39 is in a conductive state with a common external electrode 42 through the base end surface of each of the piezoelectric vibrators 20. Meanwhile, the leading end of each of the individual internal electrodes 40 is in a conductive state with corresponding individual external electrodes 43 through the leading end surface of each of the piezoelectric vibrators 20. Note that the leading end of the common internal electrode 39 is positioned slightly forward (that is, toward the base end surface) from the leading end surface of each of the piezoelectric vibrators 20, and the base end of each of the individual internal electrodes 40 is positioned at the border between the free end 20a and the base end 20b.

The individual external electrodes 43 are electrodes formed continuously between the leading end surface of each of the piezoelectric vibrators 20 and a wiring connection surface (the upper surface in FIG. 3) that corresponds to one side surface of the piezoelectric vibrators 20 in the stacking direction; the individual external electrodes 43 ensure a conductive state between a wiring pattern in the flexible cable 22, which serves as a wiring member, and each of the individual internal electrodes 40. A portion of each of the individual external electrodes 43 on the side of the wiring connection surface is formed so as to continue from the base end 20b toward the leading end side. The common external electrode 42 is an electrode formed continuously between the base end surface of each of the piezoelectric vibrators 20, the wiring connection surface, and an anchor plate attachment surface (the lower surface in FIG. 3) that corresponds to the other side surface of the piezoelectric vibrators 20 in the stacking direction; the common external electrode 42 ensures a conductive state between the wiring pattern in the flexible cable 22 and the common internal electrode 39. A portion of the common external electrode 42 on the side of the wiring connection surface is formed so as to continue toward the base end surface from slightly before the ends of the individual external electrodes 43, and a portion on the side of the anchor plate attachment surface is formed so as to continue toward the base end from a position slightly forward from the leading end surface of the vibrator.

The stated base end 20b is a non-active portion that does not extend/shrink even when the piezoelectric material 41 in the active region A is active. The flexible cable 22 is disposed on the side of the wiring connection surface of the base end 20b, and the individual external electrodes 43 and common external electrode 42 are electrically connected to the flexible cable 22 at the base end 20b. Driving signals are applied to the individual external electrodes 43 through the flexible cable 22.

The flow channel unit 18 is configured by bonding the nozzle plate 24 to one surface of a flow channel formation substrate 23 and a vibrating plate 25 to the other surface of the flow channel formation substrate 23. The flow channel unit 18 is provided with a reservoir 26 (a common liquid chamber), an ink supply opening 27, pressure chambers 28, nozzle communication openings 29, and nozzles 30. A serial ink flow channel that extends from the ink supply opening 27 to the nozzles 30, passing through the pressure chambers 28 and the nozzle communication openings 29, is formed in correspondence with each of the nozzles 30.

The nozzle plate 24 is a thin plate made of a metal such as stainless steel, in which a plurality of the nozzles 30 have been opened in row form at a pitch corresponding to the dot formation density (for example, 180 dpi). A plurality of nozzle rows (nozzle groups) in which the nozzles 30 are arranged in a row are provided in the nozzle plate 24, and each nozzle row is configured of, for example, 180 nozzles 30. The surface of the nozzle plate 24 in which ink is ejected through the nozzles 30 corresponds to the nozzle formation surface Sn according to the invention. Meanwhile, as shown in FIG. 4, the nozzle plate 24 according to this embodiment is both electrically connected to the flushing box 13 and grounded using wires or the like. Through this, an equal voltage (potential) is provided to the nozzle formation surface Sn and the flushing box 13.

The stated vibrating plate 25 has a dual-layer structure in which an elastic film 32 has been layered upon a support plate 31. In this embodiment, the vibrating plate 25 is created using a complex plate material, in which a stainless steel plate, which is a type of metallic plate, is used as the support plate 31, and a resin film, serving as the elastic film 32, is laminated to the surface of the support plate 31. A diaphragm portion 33 that causes the volume of the corresponding pressure chamber 28 to change is provided in the vibrating plate 25. Furthermore, a compliance portion 34 that partially seals the reservoir 26 is provided in the vibrating plate 25.

The diaphragm portion 33 is created by partially removing the support plate 31 through an etching process or the like. In other words, the diaphragm portion 33 includes an island portion 35 that is affixed to the tip surface of the free end 20a of the corresponding piezoelectric vibrator 20, and a thin elastic portion that surrounds this island portion 35. The compliance portion 34 is created by removing the support plate 31 from the region opposite to the opening surface of the reservoir 26 using the same type of etching process as with the diaphragm portion 33, and functions as a damper that absorbs pressure fluctuations in the liquid held within the reservoir 26.

Because the leading end surface of the piezoelectric vibrator 20 is bonded to the island portion 35, the volume of the corresponding pressure generation chamber 28 can be changed by causing the free end 20a of the piezoelectric vibrator 20 to extend/shrink. Pressure fluctuations occur in the ink within the pressure chamber 28 as a result of this volume fluctuation. The recording head 2 ejects ink droplets through the nozzles 30 using this pressure fluctuation.

The cover member 45 is a member that protects the side surfaces of the flow channel unit 18, the side surfaces of the case 16, and so on, and is manufactured from a conductive plate-shaped material such as stainless steel or the like. Part of the cover member 45 in this embodiment makes contact with the edges of the nozzle formation surface Sn in a state in which the nozzles 30 of the nozzle plate 24 are exposed, and is electrically conducted with the nozzle plate 24.

As shown in FIG. 1 and FIG. 4, the platen 5 is disposed so that a gap is present between the platen 5 and the nozzle formation surface Sn of the recording head 2 when recording operations are carried out. In this embodiment, the platen 5 is formed in a plate-shape that is long in the main scanning direction, and a plurality of support protrusions 5a are formed protruding at predetermined intervals along the lengthwise direction of the surface thereof. Each of the support protrusions 5a protrudes further upward (toward the recording head 2 during recording operations) than the surface of the platen. The upper surfaces of the support protrusions 5a serve as contact surfaces that support the recording paper 6, and partially support the rear surface of the recording paper 6 (that is, the surface on the opposite side to the recording surface on which the ink droplets land). Taking into consideration the thinnest recording paper 6 that will be supported as a recording target for the printer 1, the distance from the upper surface of the support protrusions 5a to the nozzle formation surface Sn is set so that a distance PG that spans from the surface of the recording paper 6 (the recording surface on which the ink droplets land) to the nozzle formation surface Sn is a landing-capable distance. Here, the “landing-capable distance” refers to a distance at which at least the main liquid droplets in the ink droplets ejected through the nozzles 30 are capable of landing with certainty on the landing target in a state in which there is no influence from electrical fields or the like. For example, in the case where the recording paper 6 is approximately 0.1 mm thick and the landing-capable distance is approximately 1.5 to 1.7 mm, the distance from the upper surface of the support protrusions 5a to the nozzle formation surface Sn is set to approximately 1.6 to 1.8 mm.

Meanwhile, an ink absorption portion 5b is provided in a location in the surface of the platen 5 that is separate from the support protrusions 5a. This ink absorption portion 5b is configured of, for example, a porous material capable of absorbing liquid, such as felt, a urethane sponge, or the like; the ink absorption portion 5b receives and absorbs ink droplets and the like whose landing positions have shifted and that therefore did not land on the recording paper 6.

The flushing box 13, which collects ink droplets ejected from the recording head 2 during flushing operations, is disposed at an end of the platen 5 in the main scanning direction. Specifically, the flushing box 13 is disposed in a region that is distanced from the region of the platen 5 in which ink droplets are ejected onto the recording paper 6 (an ink ejection region); more specifically, the flushing box 13 is disposed in a position located further toward the outside of the ink ejection region in the main scanning direction and that is located further outside than the end of the recording paper 6 in the width direction when the largest size of recording paper 6 that can be handled by the printer 1 (a maximum recording paper width) is located on the platen 5. Although it is desirable for a flushing box 13 to be provided on both sides of the platen 5 in the main scanning direction, it is acceptable to provide the flushing box 13 on only one side thereof. Meanwhile, as shown in FIG. 4, the flushing box 13 according to this embodiment is formed in a box-shape whose top surface (that is, the surface facing the recording head 2) is open, and is formed of a conductive material such as a metal; the interior thereof is filled with an ink absorption material 14 configured of, for example, an insulating urethane sponge or the like. The top surface of this ink absorption material 14 corresponds to a landing surface Sa on which the ink droplets land during flushing operations. The flushing box 13 is disposed upon a support platform (for example, the main section of the platen 5 if that main section is extended to below the flushing box 13), so that a distance d between the landing surface Sa and the nozzle formation surface Sn of the recording head 2 during flushing operations is smaller than the aforementioned distance PG from the surface of the recording paper 6 to the nozzle formation surface Sn (that is, the landing-capable distance). In addition, as described above, because the nozzle plate 24 and the flushing box 13 are set to a ground potential, the nozzle formation surface Sn and the landing surface Sa are also set to a ground potential.

Next, the flushing operations, and the collection of mist that occurs along therewith, will be described. The flushing operations are executed during recording operations (printing operations), in between individual recording operations every set interval or every predetermined number of passes that correspond to a single scan of the recording head while temporarily stopping the recording operations; in the flushing operations, ink droplets are ejected through the nozzles 30 of the recording head 2 toward the ink absorption material 14 (landing surface Sa) of the flushing box 13 in order to expel thickened ink, bubbles that have intermixed with the ink, and so on.

The ink ejected through the nozzles 30 by the flushing operations are stretched out during flight, which splits the ink into an initial main liquid droplet Md (a primary liquid droplet), a smaller first satellite liquid droplet Sd1 that is produced following the main liquid droplet, and an even smaller second satellite liquid droplet Sd2 (see FIG. 4). Because the nozzle formation surface Sn and the landing surface Sa are set to the same potential in this embodiment, an electrical field is not formed between at least the edges of the nozzles 30 in the nozzle formation surface Sn and the landing surface Sa opposed thereto; accordingly, the ink droplets Md, Sd1, and Sd2 are not charged from electrostatic induction. Furthermore, because the distance d between the landing surface Sa and the nozzle formation surface Sn is smaller than the landing-capable distance in this embodiment, it is easier for the main liquid droplet Md and the first satellite liquid droplet Sd1 to land on the ink absorption material 14. Meanwhile, even if the second satellite liquid droplet Sd2 suddenly loses velocity due to viscous resistance of the air, the distance from when the droplet is ejected to when the droplet lands has been reduced, and thus part or all of the second satellite liquid droplet Sd2 can be caused to land upon the ink absorption material 14 of the flushing box 13. Incidentally, it is known that free-floating liquid droplets experience an increased positive charging due to the Lenard effect, or in other words, due to evaporation, breakup, and so on of surface portions during flight. However, because the distance from when the droplet is ejected to when the droplet lands has been reduced in this embodiment, the amount of time for which the ink droplets Md, Sd1, and Sd2 are floating freely can be reduced, which makes it possible to suppress positive charging arising due to the Lenard effect.

In this manner, according to this embodiment, the nozzle formation surface Sn and the landing surface Sa are set to the same ground potential, and thus an electrical field is not formed between the two surfaces; this makes it possible to prevent the second satellite liquid droplet Sd2 from being charged through electrostatic induction. In addition, setting the distance between the landing surface Sa and the nozzle formation surface Sn to be smaller than the landing-capable distance makes it possible to ensure that the second satellite liquid droplet Sd2 lands on the ink absorption material 14 of the flushing box 13 before losing velocity, which makes it possible to suppress the occurrence of misting. Furthermore, the flight time of the second satellite liquid droplet Sd2 is reduced, which makes it possible to suppress positive charging due to the Lenard effect. This reduces mist adhering to other components within the printer 1 (for example, components that are negatively charged with ease, such as motors, driving belts, linear scales, and so on). As a result, malfunctions caused by the adherence of mist are suppressed, and the durability and reliability of the printer 1 is increased.

Incidentally, the configuration of the flushing box 13 is not limited to that described in the aforementioned embodiment. For example, the flushing box 13 according to a second embodiment and shown in FIG. 5 is filled with a conductive ink absorption material 48 configured of a conductive sponge or the like. The conductive ink absorption material 48 is both electrically connected to the nozzle plate 24 through a wire or the like and grounded. Through this, the potential of the landing surface Sa formed by the conductive ink absorption material 48 can be set to the same potential as the nozzle formation surface Sn with certainty, regardless of the material of the flushing box 13. Note that because other configurations are identical to those of the printer 1 described in the first embodiment, descriptions thereof will be omitted here.

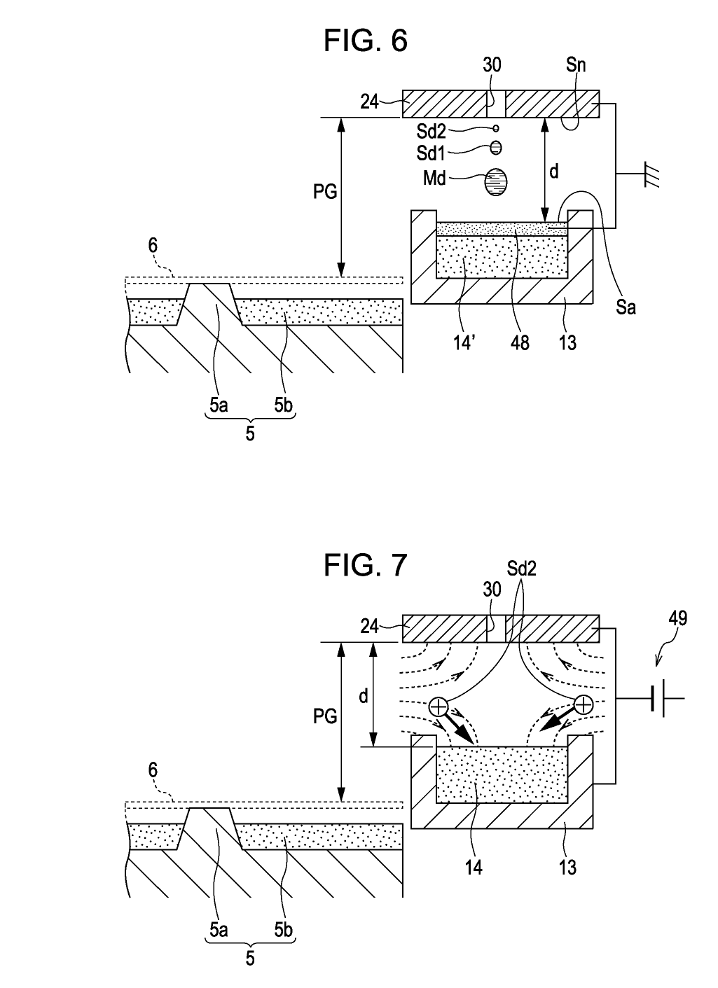

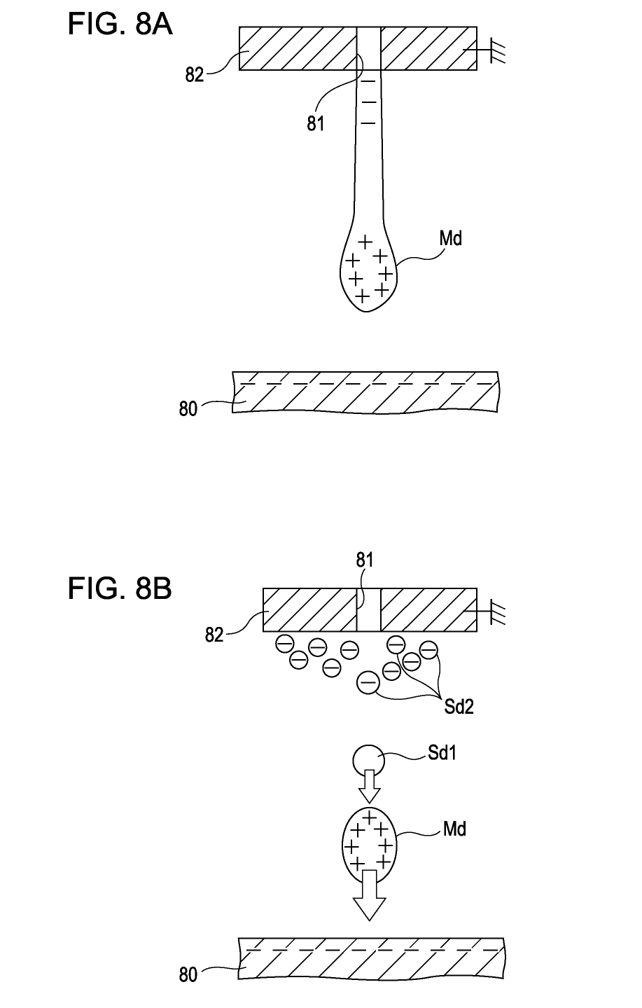

Meanwhile, the flushing box 13 according to a third embodiment and shown in FIG. 6 is filled with a layered absorption material, in which the conductive ink absorption material 48 that forms the landing surface Sa is provided as an upper layer and an ink absorption material 14′ configured of a different material from the conductive ink absorption material 48 is provided as a lower layer. The conductive ink absorption material 48 is both electrically connected to the nozzle plate 24 through a wire or the like and grounded. Through this, the potential of the landing surface Sa can be set to the same potential as the nozzle formation surface Sn with certainty regardless of the material of the ink absorption material 14′ in the lower layer. For example, an inexpensive material that can hold ink with ease can be selected for the ink absorption material 14′, regardless of the electrical properties thereof. Note that because other configurations are identical to those of the printer 1 described in the second embodiment, descriptions thereof will be omitted here.

Furthermore, although the nozzle formation surface Sn and the landing surface Sa are set to the ground potential in the aforementioned embodiments, the invention is not limited thereto. For example, although the flushing box 13 according to a fourth embodiment and shown in FIG. 7 is electrically connected to the nozzle plate 24 through a wire in the same manner as in the first embodiment, those elements are also connected to a power source 49 (corresponding to a “voltage application unit” according to the invention) that applies a negative voltage. Meanwhile, the flushing box 13 is filled with the insulating ink absorption material 14. Through this, when the first ink droplet is absorbed by the ink absorption material 14 during the flushing operations, the nozzle formation surface Sn and the landing surface Sa are both set to a negative potential through that ink. As a result, while an electrical field is not formed between at least the edges of the nozzles 30 in the nozzle formation surface Sn and the landing surface Sa opposed thereto as in the first embodiment, an electrical field is formed toward the nozzle formation surface Sn and the landing surface Sa (see the dotted line arrows in FIG. 7) from other components within the printer 1 and so on, at the outer edge of the nozzle formation surface Sn and the outer edge of the landing surface Sa. Note that the ink absorption material that fills the flushing box 13 is not limited to the insulating ink absorption material 14, and can also be formed using the conductive ink absorption material 48. In the case where the material is formed using the conductive ink absorption material 48, the potential of the nozzle formation surface Sn and the landing surface Sa can be set to a negative potential through the flushing box 13 even if ink droplets are not absorbed by the ink absorption material 14. Note that because other configurations are identical to those of the printer 1 described in the first embodiment, descriptions thereof will be omitted here.

In this manner, an electrical field is not formed between at least the edges of the nozzles 30 in the nozzle formation surface Sn and the landing surface Sa, and thus the second satellite liquid droplet Sd2 are not charged through electrostatic induction. In addition, because the distance from when the droplet is ejected to when the droplet lands has been reduced, it is possible to suppress positive charging arising due to the Lenard effect. However, it is not possible to completely prevent the second satellite liquid droplet Sd2 from being charged due to the Lenard effect. Nevertheless, even in the case where the second satellite liquid droplet Sd2 has been positively charged due to the Lenard effect, an electrical field is formed from the other components within the printer 1 and so on toward the nozzle formation surface Sn and the landing surface Sa; accordingly, the second satellite liquid droplet Sd2 can be caused to land on the nozzle formation surface Sn or the landing surface Sa, and thus the occurrence of misting can be suppressed with even more certainty. Note that the second satellite liquid droplet Sd2 moves downward (toward the landing surface Sa) with ease during ejection due to inertia and gravity, and the positive charge becomes stronger as the second satellite liquid droplet Sd2 moves downward; thus the second satellite liquid droplet Sd2 lands more easily on the landing surface Sa than on the nozzle formation surface Sn, and is thus collected into the ink absorption material 14 of the flushing box 13. Even if part of the second satellite liquid droplet Sd2 did land on the nozzle formation surface Sn, that droplet would be wiped away by the wiper member 12.

Incidentally, although the aforementioned embodiments describe the flushing box 13 or the conductive ink absorption material 48 being electrically connected to the nozzle plate 24 through a wire or the like, the invention is not limited thereto. Even if these elements are not electrically connected, individually grounding or connecting those elements to a power source can also set the nozzle formation surface Sn and the landing surface Sa to the same potential. By employing such a configuration, the voltage applied to the nozzle formation surface Sn and the landing surface Sa other than the flushing operations, such as during the recording operations, can be controlled, making it possible to apply any desired voltages on an individual basis. It is sufficient for the configuration to be such that the nozzle formation surface Sn and the landing surface Sa are set to the same potential during the flushing operations.

As long as the liquid ejecting apparatus is one capable of using a pressure generation unit to control the ejection of a liquid, the invention is not limited to a printer, and can be applied in various types of ink jet recording apparatuses such as a plotter, a facsimile apparatus, a copy machine, or the like; liquid ejecting apparatuses aside from recording apparatuses, such as, for example, display manufacturing apparatuses, electrode manufacturing apparatuses, chip manufacturing apparatuses; and so on. In such display manufacturing apparatuses, liquids having R (red), G (green), and B (blue) coloring materials are ejected from coloring material ejecting heads. Meanwhile, in electrode manufacturing apparatuses, electrode materials are ejected in liquid form from electrode material ejecting heads. In chip manufacturing apparatuses, bioorganic matters are ejected in liquid form from bioorganic matter ejection heads.

What is claimed is:

1. A liquid ejecting apparatus comprising:
a liquid ejecting head, having a nozzle formation surface in which a nozzle that ejects a liquid is formed and a pressure generation unit that causes a fluctuation in a pressure of a liquid within a pressure chamber, that causes the liquid to be ejected through the nozzle toward a landing target by driving the pressure generation unit;
a support unit that, during ejection operations, supports the landing target that is disposed at a landing-capable distance from the nozzle formation surface of the liquid ejecting head; and
a liquid droplet collection unit disposed in a location that is distanced from an ejection region in the support unit, the ejection region being a region in which the liquid is ejected onto the landing target from the liquid ejecting head,
wherein the liquid droplet collection unit includes a landing surface on which the liquid lands when carrying out flushing operations that eject the liquid from the liquid ejecting head into the liquid droplet collection unit; and
the distance between the landing surface and the nozzle formation surface of the liquid ejecting head when carrying out the flushing operations is set to be smaller than the landing-capable distance, and the nozzle formation surface and the landing surface are set to the same voltage at least during the flushing operations.

2. The liquid ejecting apparatus according to claim 1, further comprising:
a voltage application unit that applies a voltage to the nozzle formation surface and the landing surface,
wherein a negative voltage is applied to the nozzle formation surface and the landing surface.
